(19) United States
(12) Patent Application Publication
(10) Pub. No.: US 2026/0085950 A1
(43) Pub. Date: Mar. 26, 2026

(54) Incremental magnetic encoder

(71) Applicant: THALES, Meudon (FR)

(72) Inventor: Mathieu BESNARD, MERIGNAC (FR)

(21) Appl. No.: 19/328,127

(22) Filed: Sep. 13, 2025

(30) Foreign Application Priority Data
Sep. 20, 2024 (FR) 2410038

(51) Int. Cl. G01D 5/245

(52) U.S. Cl. CPC G01D 5/2451

(57) ABSTRACT

An incremental magnetic encoder defining an encoder axis and including a fixed body and a movable body, one of the bodies, known as the first body, including a first ring extending in a first longitudinal direction and a first circumferential direction, one of the first directions corresponding to the first encoding direction, the first ring defining at least two different magnetic alternations, the other body, known as the second body, including at least one first notching tooth capable of being placed opposite each magnetic alternation of the first ring to create a notch with at least two different notch steps depending on the position of the second body, a first pair of magnetic detectors positioned opposite the first ring.

### REFERENCE TO RELATED APPLICATIONS

This application is a U.S. non-provisional application claiming the benefit of French Patent Application No. 24 10038 filed on Sep. 20, 2024, the contents of which are incorporated herein by reference in their entirety.

### TECHNICAL FIELD OF THE INVENTION

This invention relates to an incremental magnetic encoder.

More particularly, the present invention relates to an encoder capable of providing binary logic signals representing increments of relative position of two elements of the encoder, the two elements being movable relative to each other. Advantageously, such an encoder is applicable in the aeronautical field, for example in an aircraft cockpit.

### BACKGROUND OF THE INVENTION

Typically, in an application for aeronautical equipment, an angular and/or linear encoder can be used to indicate to an autopilot computer an altitude or speed set point that the operator selects by pressing an encoder control knob. The reliability of the encoder and the information it delivers is therefore an essential element of the encoder. The typical requirement for an aeronautical encoder may include one or more of the following: compactness, ability to make multi-turn rotations and/or a linear stroke, incrementing and notch capability, etc. In order to be certified, the aeronautical encoder must also be able to meet high DAL (Design Assurance Level) safety levels, in particular DAL A.

In particular, with regard to compactness, an encoder typically has a control knob with a diameter of between 10 and 100 mm and a length of between 5 and 50 mm (typically Ø 16 mm×lg 16 mm) and a body with a diameter of between 10 and 100 mm and a length of between 5 and 100 mm (typically Ø 25 mm×lg 50 mm) hidden behind the fixing panel or fixed in front of this panel. In the latter case, the knob encompasses the body of the encoder which is fixed to the panel and allows it to be positioned around, or even slightly overlapping, a monitor or screen.

In terms of incrementing capacity, each notch (or step) constitutes an increment of a rotation or translation counting unit. Angular or linear resolution is defined by the notch (or step). The number of steps per revolution is between 1 and 32 steps (typically 12 steps). The number of translation steps is between 1 and 10 notches (typically 1 notch in each direction to obtain a push/pull knob with a stable state between the two notches).

To detect the direction of movement in rotation and/or translation, the encoder generally has at least two detectors (for rotation and translation respectively) physically offset from each other (typically an odd number of quarter steps). These two detectors encode rotational and/or translational movement in two bits. The encoding gives the following successive values: 00, 01, 11, 10 when the encoder rotates and/or translates in one direction and the following successive values: 00, 10, 11, 01 when the encoder rotates and/or translates in the opposite direction. It is therefore possible to determine not only the occurrence of a rotational and/or translational increment (change of state of one of the bits) but also the direction of rotation (by comparison between a detected state and the immediately preceding state).

With regard to the notching capability of encoders, going past an encoded notch generally results in tactile feedback that an operator should feel when operating the device. For example, the angular notch torque can be in the order of 1 to 700 mN·m (typically 12 mN·m) and the linear notch force in the order of 0.5 to 20 N (typically 6 N).

The most complex encoders feature encoding and notching in both rotation and translation. Encoding and notching in rotation must not be inhibited by encoding and notching in translation. In this case, detection and notching in both rotation and translation must be able to be used simultaneously without loss of performance. For example, to enter a speed, the driver must simultaneously push the encoder knob and turn it to the chosen value.

Finally, in some cases, to secure the encoder and in particular to guarantee its DAL security level (for example DAL A), the detection (or encoding) functions are at least doubled.

To meet the above requirements, the encoders used in aerospace applications are often based on opto-mechanical solutions (optical detection and mechanical notching) or electromechanical solutions (detection by electrical contact and mechanical notching) and sometimes magneto-mechanical solutions (magnetic detection and mechanical notching) or opto-magnetic solutions or even purely magnetic solutions.

For example, opto-mechanical encoders are described in documents FR 2937129 and FR 2954491. According to these documents, an optical encoder is used to detect rotation and/or translation (encoding), while at least one ball pressed by a spring against a ball track (or cam) is used to hold it in a stable position (notching). Although these latest innovations meet the needs described above and aim to simplify their production, opto-mechanical and electromechanical encoders remain complex assemblies made up of numerous high-precision parts.

More generally, current mechanical notching solutions generate friction (e.g., ball against cam) and wear, which limits the life of the device, particularly when plastic parts are used. In electromechanical encoders, detection and notching are sometimes linked by at least one common mechanical part which is used for both click and detection via an electrical contact. The latter is often exposed to the risk of wear and fretting corrosion, which limits the life of the device. In addition, in opto-mechanical and sometimes electromechanical devices, detection and notching are decoupled, i.e., they result from different solutions and/or phenomena and are quite far apart physically. This decoupling increases the number of parts and therefore the risk of a mismatch between detection and notching. In the case of complex and secure encoders, the number of parts is even greater. In this case, to ensure good performance and reliability, today's complex encoders require high-precision parts, which are more expensive.

Document FR 2370350 is also known, describing a rotary magnetic encoder with moving magnets in which notching and encoding are derived from the magnetic phenomenon. However, the encoder in this document is only rotary and uses moving magnets which are exposed to the risk of rubbing and jamming.

To sum up, electromechanical solutions present the greatest risk of fatigue in both notching and encoding, as they generate the most friction. The electrical encoding is also exposed to fretting corrosion. These drawbacks reduce reliability and limit the device's lifespan.

Opto-mechanical and magneto-mechanical solutions preserve the risk of fatigue in mechanical notching.

Opto-magnetic solutions use different contactless phenomena. These solutions are more cumbersome if the desire is to make a more complex encoder (e.g., rotary encoder with push/pull) that is also more secure.

Purely magnetic solutions cannot meet all the above requirements.

Lastly, document FR 3135791 offers a purely magnetic solution enabling encoding to be implemented in one of the directions chosen, for example from the direction of translation and the direction of rotation, while ensuring notching in the same direction. According to this document, encoding and notching are created by the same magnetic effect between the movable body and the fixed body. This document therefore resolves all the issues mentioned above. However, the solution proposed in this document can still be improved.

### SUMMARY OF THE INVENTION

The purpose of the present invention is to offer an incremental encoder that meets all the above-mentioned requirements, while improving the solution offered in particular by document FR 3135791.

To this end, the invention relates to an incremental magnetic encoder defining an encoder axis and including a fixed body and a body movable relative to the fixed body in at least a first encoding direction and a second encoding direction perpendicular to the first encoding direction;
one of the bodies, known as the first body, including:
   a first ring extending along a first longitudinal direction coincident with the encoder axis and a first circumferential direction perpendicular to the first longitudinal direction, one of said first directions corresponding to the first encoding direction, the first ring defining at least two different magnetic alternations, each magnetic alternation extending along the first encoding direction;
the other body, known as the second body, including:
   at least one first notching tooth made of ferromagnetic or magnetic material capable of being arranged opposite each magnetic alternation of the first ring in order to create, during a movement of the movable body in the first encoding direction, notching at at least two different notch steps depending on the position of the second body relative to the first body in the second encoding direction;
   a first pair of magnetic detectors arranged opposite the first ring and configured to quantify each movement of the movable body in the first encoding direction.

Equipped with these features, the encoder according to the invention may be used for encoding in one of the chosen directions, while providing notching in the same direction. The encoding and notching are created by the same magnetic effect between the movable body and the fixed body. In addition, the encoder according to the invention makes it possible to implement different notch steps in the first encoding direction depending on the respective position of the bodies in the second encoding direction. In this way, each respective position of the bodies in the second encoding direction may be associated with a function with its own notch step. For example, the functions associated with different body positions may correspond to different setting accuracies of numerical values entered via the encoder. These specifications may, for example, correspond to fine, medium and coarse settings. This makes the use of such an encoder particularly convenient and intuitive.

“Magnetic alternation” means a succession of ferromagnetic or magnetic elements alternating their direction of magnetization according to a predetermined rule.

In some embodiments, each magnetic alternation is defined by a constant alternation step.

This ensures a constant notch step in the corresponding encoding direction.

According to some embodiments:
the first body further includes a second ring extending along a second longitudinal direction coincident with the encoder axis and a second circumferential direction perpendicular to the second longitudinal direction, one of said second directions corresponding to the second encoding direction, the second ring defining a single magnetic alternation extending along the second encoding direction;
the second body, including:
   at least one second notching tooth made of ferromagnetic or magnetic material arranged opposite the second ring to create a set of notches with the same notch step when the movable body moves in the second encoding direction;
   a second pair of magnetic detectors arranged opposite the second ring and configured to quantify each movement of the movable body in the second encoding direction.

Thanks to these features, it is possible to provide a notch in each encoding direction.

In some embodiments, the second encoding direction corresponds to translation along the encoder axis by a predetermined translational stroke length and the first encoding direction corresponds to rotation about the encoder axis.

Thanks to these features, it is possible to ensure different rotational notch steps depending on the position of the body in translation. So, to use the encoder, the operator may first make a translational movement to select the desired position and then make a rotary movement whose notch step depends on the selected translational position. A default rotational notch step may also be assigned when no translational movement is performed.

According to some embodiments, the first ring includes a plurality of elementary rings arranged coaxially next to one another in the second encoding direction, at least two elementary rings defining the two different magnetic alternations.

Thanks to these features, it is possible to achieve at least two different magnetic alternations in a simple way.

According to some embodiments, the first ring includes at least three elementary rings arranged coaxially next to each other along the second encoding direction, the elementary rings defining at least three different magnetic alternations with an increasing or decreasing alternation step along the second encoding direction.

Thanks to these features, it is possible to obtain at least three different notch steps in rotation depending on the position of the body in translation.

According to some embodiments, the second ring includes a plurality of elementary rings arranged coaxially next to one another to define the magnetic alternation along the second encoding direction;
the width of each elementary ring of the first ring is less than or equal to the width of each pair of elementary rings of the second ring.

According to some embodiments:
the second ring defines at least one central notch and two peripheral notches;
a translationally stable position being defined when the second notching tooth is positioned opposite the central notch.

Thanks to these features, it is possible to obtain a translationally stable position for the movable body and at least two peripheral positions. Each peripheral position may be reached by pressing or pulling the movable body (“PUSH/PULL” principle). Different rotational notch steps may then be associated with each of these positions. The peripheral positions may be either stable or unstable, depending on the various embodiments.

In some embodiments, the surface of the or each notching tooth has an extent less than or equal to the smallest notch step of the corresponding ring.

Thanks to these features, the notching tooth is sufficiently sensitive to ensure any notch step.

In some embodiments, the magnetic detectors of the first pair of detectors are offset from each other by a fraction of the smallest notch step.

Thanks to these features, it is possible to effectively detect each movement of the movable body corresponding to a notch step.

According to some embodiments, which the first body is the movable body and the second body is the fixed body.

Thanks to these features, in particular the notching teeth and magnetic detectors are arranged in the fixed body. As a result, the arrangement of these elements and any wiring involved may be significantly simplified.

According to some embodiments, the encoder further includes:
a magneto-rheological fluid in a space formed between the first body and the second body;
a magnetic loop configured to form a magnetic field at least in part of the said space and to modify the intensity of this magnetic field as a function of the position of the second body relative to the first body in the second encoding direction.

Thanks to these features, it is possible to modify the notch torque in the first encoding direction. Each change in the intensity of the magnetic field created by the magnetic loop modifies the viscosity of the magneto-rheological fluid.

### BRIEF DESCRIPTION OF THE DRAWINGS

These characteristics and advantages of the invention will become apparent upon reading the following description, which is given solely by way of a non-limiting example, with reference to the attached drawings, in which:

FIG. 1 is a schematic perspective view of a magnetic encoder according to a first embodiment of the invention, the encoder being partially fixed behind a panel forming a dashboard;

FIG. 2 is an exploded perspective view of the encoder of FIG. 1, the encoder including a fixed body and a movable body;

FIG. 3 shows a partial view of a section along longitudinal plane III of FIG. 1 and three other sections along the encoder axis of FIG. 1;

FIG. 4 is a perspective view of the internal functional elements of the fixed body and the movable body of FIG. 2;

FIG. 5 is a perspective view of the movable body of FIG. 2;

FIG. 6 is a cross-sectional perspective view of the movable body inserted in the fixed body of FIG. 2;

FIG. 7 is a schematic perspective view of an encoder according to a second embodiment of the invention, the encoder being fixed to a panel forming an instrument panel while remaining in front of this panel;

FIG. 8 is an exploded perspective view of the encoder in FIG. 7; and FIG. 9 is a similar view to FIG. 3, with the magnetic encoder in a third embodiment.

### DETAILED DESCRIPTION OF THE INVENTION

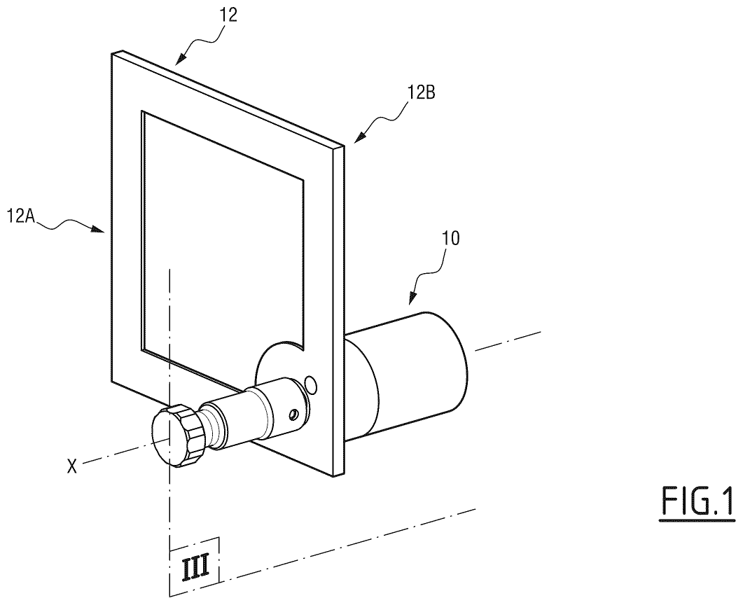

FIG. 1 illustrates an incremental magnetic encoder 10 according to a first embodiment of the invention. Preferably, the encoder 10 is mounted in a cockpit for piloting an aircraft.

By “aircraft” we mean any flying machine, such as an airplane, helicopter or drone. Such an aircraft may be flown directly from it. In this case, the cockpit is advantageously arranged inside the aircraft. In another example, such an aircraft is controlled remotely. In this case, the cockpit is located at a distance from the aircraft and has a ground station, for example. In all cases, the aircraft is configured to be piloted by an operator, for example by a pilot from the cockpit inside the aircraft.

According to the invention, the encoder 10 enables the operator to control at least one avionics function. For example, such an encoder 10 may be used by the operator to control an avionics system and forms part of a control system for such an avionics system. Alternatively, the encoder 10 forms part of a control system for several avionics systems. For example, the encoder 10 according to the invention is part of a system known as a “Flight Control Unit” (FCU) or “Integrated Standby Instrument System” (ISIS) or “Closer Control Device” (CCD) or “Keyboard Cursor Control Device”(KCCD), etc.

In the example shown in FIG. 1, the encoder 10 is partially integrated in a panel 12. This panel 12 forms, for example, an aircraft cockpit instrument panel for one of the aforementioned control systems. In the example shown in FIG. 1, the encoder 10 is arranged partly in the front part 12A of the panel 12 and partly in the rear part 12B of this panel 12. In particular, in the example shown in FIG. 1, the front part 12A of the panel 12 faces the operator, while the rear part 12B of this panel faces the inside of the dashboard. Of course, other examples of arrangement of the encoder 10 in relation to the panel 12 or in relation to any other attachment means are also possible.

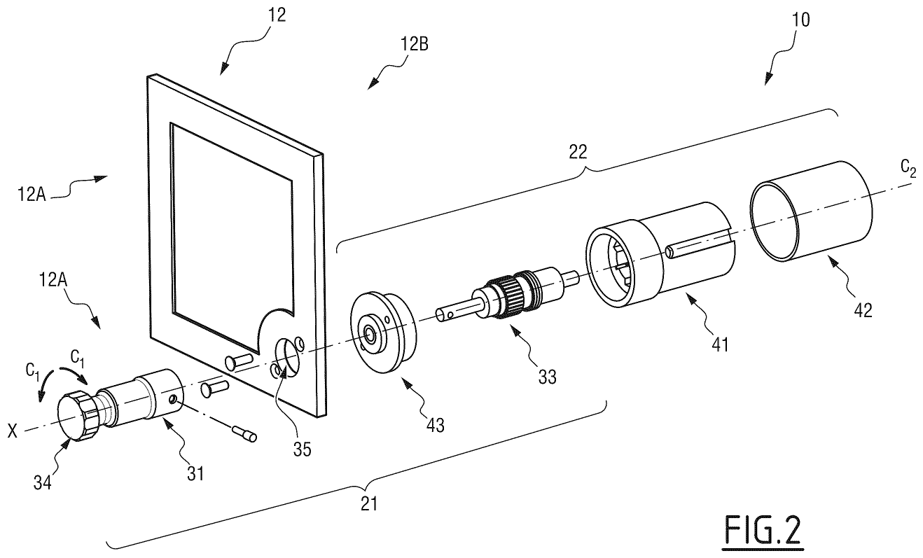

With reference to FIG. 2, the encoder 10 includes a movable body 21, also referred to in this example as the first body, and a fixed body 22, also referred to in this example as the second body.

The movable body 21 includes a knob 31 and a rotor 33.

The knob 31 projects from the panel 12 and is arranged in the front part 12A of the panel 12. The knob 31 may move in translation along an encoder axis X and in rotation about the encoder axis X. More particularly, the knob 31 is movable in a first encoding direction C1, which in this example corresponds to the direction of rotation about the encoder axis X, and a second encoding direction C2, which in this example corresponds to the direction of translation along the encoder axis X. Advantageously, the knob 31 is movable in each direction along each encoding direction C1, C2. In particular, in the direction of rotation, the knob 31 is rotatable clockwise and counter-clockwise, and in the direction of translation, the knob 31 is movable in the direction towards the instrument panel and towards the operator. Advantageously, the knob 31 defines in particular a knob surface 34 which is intended to be oriented towards the operator. This surface 34 therefore represents an external surface of the knob 31 which is visible to the operator and may be grasped by the operator.

The rotor 33 extends along the encoder axis X so as to form an integral connection with the knob 31 at one of its ends. In the same way as the knob 31, the rotor 33 may move in the first encoding direction C1 and in the second encoding direction C2 in each of the aforementioned directions of movement. The rotor 33 receives internal functional elements from the movable body 21, which will be explained in more detail later.

The fixed body 22 includes a support 41, a cover 42 and a flange 43.

The flange 43, for example, is located in a through-hole 35 in the panel 12 and supports the knob 31 and rotor 33. In the example shown in FIG. 2, the flange 43 is fixed to the panel 12 while remaining in the rear part 12B of the panel, for example using screws accessible from the front part 12B of the panel 12.

The support 41 receives functional internal elements of the fixed body 22 which are intended to cooperate with the functional internal elements of the movable body 21 as will be explained in more detail later. In particular, and as will become apparent later, the functional internal elements of the fixed body 22 are held by the support 41 at a distance from those of the movable body 21. To do this, the support 41 is configured to at least partially receive the rotor 33 with the functional internal elements of the movable body 21 carried by this rotor 33.

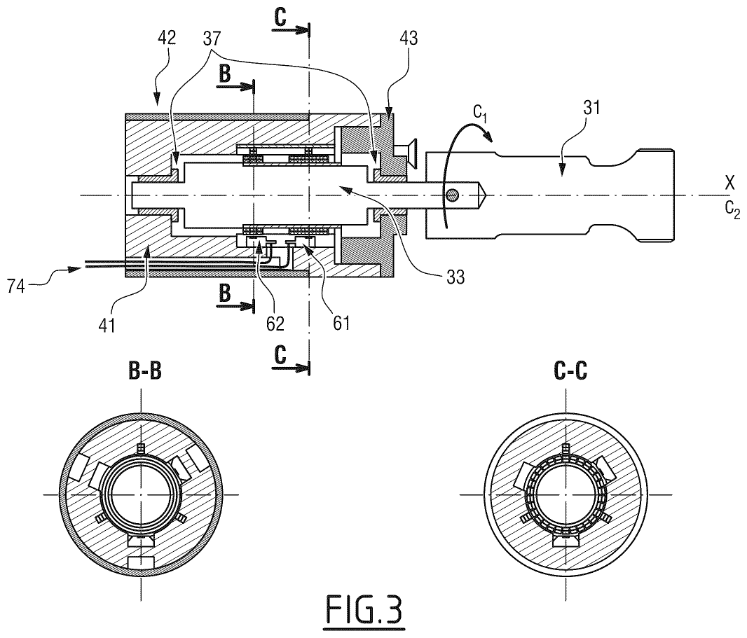

The support 41, for example, is connected to the movable body 21 via a link that is movable in each encoding direction. For example, this connection may be formed at each end of the rotor 33 and have plain bearings, for example polymer bearings or sintered bronze bearings. These bearings are preferably flanged to act as mechanical stops. According to another example, these bearings are rolling element bearings such as ball bushes. FIG. 3 shows the bearings 37 connecting the rotor 33 to the second body 22. In this example, the bearings 37 connect one end of the rotor 33 directly to the support 41 and the other end of the rotor 33 to the support 41 via the flange 43. In this example, the flange 43 is configured to cooperate with the support 41 in order to secure it to the panel 12.

The cover 42 is designed to protect all the components of the encoder 10 which are arranged in the rear part 12B of the panel 12.

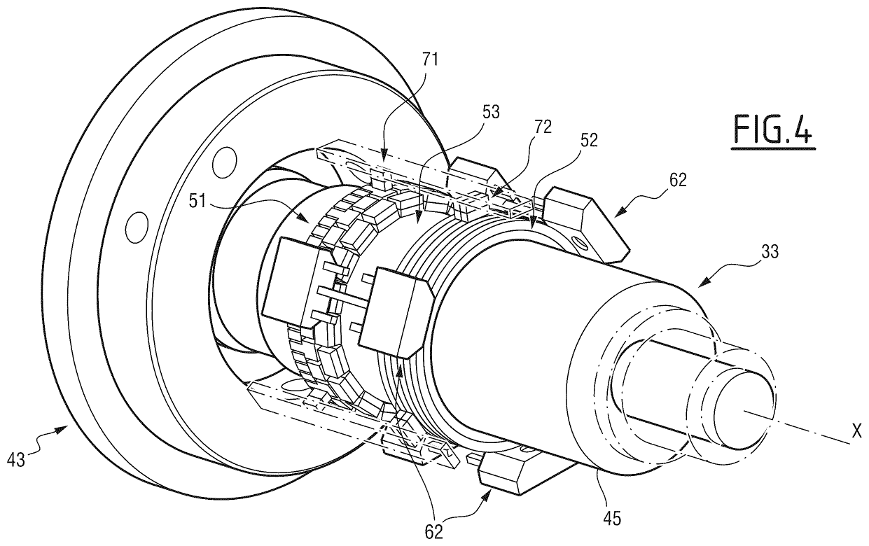

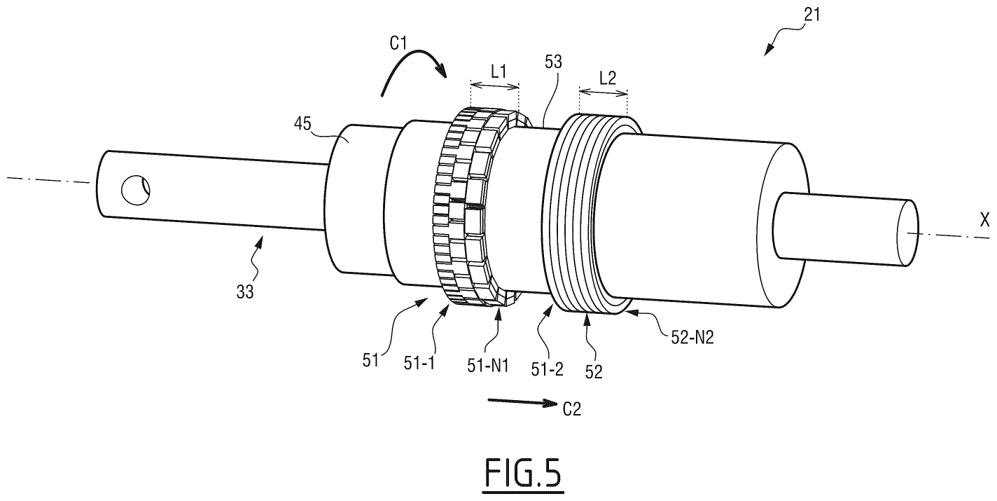

In the example shown in FIGS. 4 and 5 illustrating in more detail the internal functional elements of the fixed body 22 and the movable body 21, the rotor 33 has, for example, a cylindrical shaft 45 extending along the encoder axis X.

With reference to FIGS. 4 and 5, the internal functional elements of the movable body 21 include a first ring 51, known as the rotation ring, and a second ring 52, known as the translation ring. Each of these rings 51, 52 is fixed to the shaft 45 along the encoder axis X and remains spaced from the other ring 51, 52. In some embodiments, the rings 51, 52 are interconnected by a magnetic or ferromagnetic part 53 to improve the efficiency of the encoder (greater torque and notch force without increasing the size of the fixed magnets) and to prevent field leakage and external interference emissions. This part 53 has, for example, a sleeve or tube inserted on the shaft 45, the two rings 51, 52 being fixed on this sleeve.

In addition, each of these rings 51, 52 has one or more axial magnetic alternations in the case of the translation ring 52 and circumferential magnetic alternations in the case of the rotation ring 51.

In the example shown in FIGS. 4 and 5, the translation ring 52 has a single axial magnetic alternation. In particular, this translation ring 52 extends along the encoder axis X and has a plurality of elementary rings 52-1, . . . , 52-N2 arranged side by side, for example by gluing. Each elementary ring 52-1, . . . , 52-N2 is made, for example, from a single block or from a plurality of parallelepiped magnets or arc magnets. Such an elementary ring may also come from a “poly magnet” or a “programmable magnet”called Polymagnets®.

In order to achieve axial magnetic alternation, in the example shown in FIG. 5, these elementary rings 52-1, . . . , 52-N2 have radial magnetization and are arranged next to each other so that adjacent rings are magnetized in opposite directions in the radial direction. In another possible arrangement, axial magnetic alternation is achieved using a Halbach-type arrangement. In particular, according to this type of arrangement, the elementary rings are magnetized alternately in the radial and circumferential directions. In addition, the direction of magnetization of each elementary ring is chosen so as to concentrate the magnetic field on the surface of the translation ring 52 facing the internal functional elements of the fixed body 22. In the example of the respective arrangement of the movable body 21 and the fixed body 22 in FIG. 2, such a magnetic field is concentrated on the outer surface of the translation ring 52.

The translation ring 52 has a width L2 corresponding to its extent along the encoder axis X. This width L2 is formed by the sum of the widths of the individual rings 52-1, . . . , 52-N2 forming this translation ring 52. The width of each elementary ring or of each pair of elementary rings forms a translational notch step. In one example, the individual rings have the same width. In this case, the translation ring 52 has a uniform translational notch step.

In the example shown in FIGS. 4 and 5, the number N2 of elementary rings 52-1, . . . , 52-N2 is equal to 6. In other words, these elementary rings form three pairs of rings, each pair being made up of adjacent rings with different magnetizations. Among these pairs of elementary rings, one pair of elementary rings is arranged between the other two pairs and is then called the central pair. The other two pairs are called peripheral pairs. The central pair then has a central notch and the peripheral pairs have peripheral notches.

The rotation ring 51 also extends along the encoder axis X and has a width L1 corresponding to its longitudinal extent. Advantageously, the width L1 is substantially the same as the width L2 of the translation ring 52. In some other examples, the width L1 is substantially less than the width L2, for example. The rotation ring 51, for example, has the same diameter as the translation ring 52.

According to the invention, the rotation ring 51 has a plurality of circumferential magnetic alternations with different alternation steps. To do this, the rotation ring 51 has a plurality of elementary rings 51-1, . . . , 51-N1 arranged side by side along the encoder axis X. At least two elementary rings 51-1, . . . , 51-N1 have different circumferential magnetic alternations and therefore different alternation steps. Advantageously, all the elementary rings 51-1, . . . , 51-N1 have different circumferential magnetic alternations and therefore different alternation steps.

The circumferential magnetic alternation of each elementary ring 51-1, . . . , 51-N1 forming the rotation ring 51 is achieved by a particular arrangement of a plurality of elementary parts forming this elementary ring 51-1, . . . , 51-N1, each elementary part having, for example, a permanent magnet. Each elementary part may, for example, have a substantially parallelepiped shape which is elongated along the encoder axis X. This shape may, for example, be slightly curved to form an arc of a circle around the encoder axis X. The individual parts are arranged side by side, for example by gluing in the circumferential direction. The circumferential extent of each elementary part forms an alternating step that also forms a rotational notch step. This is a homogeneous alternating step when all the elementary parts have the same circumferential extent. As in the case of the elementary rings 52-1, . . . , 52-N2 of the translation ring 52, each elementary part is made, for example, from a single block or from several parallelepiped magnets or arc-shaped magnets. Such an elementary part may also come from a “poly magnet” or a “programmable magnet” called Polymagnets®.

The component parts of the same component ring 51-1, . . . , 51-N1 of the rotation ring 51 have a radial magnetization and are arranged next to each other so that the adjacent component parts are magnetized in opposite directions in the radial direction. In another possible arrangement, circumferential magnetic alternation is achieved using a Halbach-type arrangement. In particular, according to this type of arrangement, the individual parts are magnetized alternately in the radial and circumferential directions. In addition, as in the previous case, the direction of magnetization of each elementary part is chosen so as to concentrate the magnetic field on the surface of the rotation ring 51 facing the internal functional elements of the fixed body 22. In the example of the respective arrangement of the movable body 21 and the fixed body 22 in FIG. 2, such a magnetic field is concentrated on the outer surface of the rotation ring 51.

To ensure different alternating steps between the different elementary rings 51-1, . . . , 51-N1 of the rotation ring 51, the elementary parts of these different elementary rings 51-1, . . . , 51-N1 have different circumferential extents. Between the various elementary rings 51-1, . . . , 51-N1 these circumferential extents may progressively decrease or increase along the encoder axis X. Thus, the alternation steps and consequently the notch steps of the elementary rings 51-1, . . . , 51-N1 of the rotation ring 51 progressively decrease or increase along the encoder axis X. Thus, in the example of FIGS. 4 and 5, the number N1 of elementary rings 51-1, . . . , 51-N1 is equal to 3 and three notch steps are defined, namely fine, medium and coarse. In other words, in this example, the notch step decreases progressively along the encoder axis X.

Advantageously, the elementary rings 51-1, . . . 51-N1 of the rotation ring 51 all have the same width. For example, the width of each elementary ring 51-1, . . . , 51-N1 of the rotation ring 51 is equal to the width of each pair of elementary rings 52-1, . . . , 52-N2 of the translation ring 52. In other words, the width of each elementary ring 51-1, . . . , 51-N1 of the rotation ring 51 is twice the width of each elementary ring 52-1, . . . , 52-N2 of the translation ring 52. According to another example, the width of each elementary ring 51-1, . . . , 51-N1 of the rotation ring 51 is less than the width of each pair of elementary rings 52-1, . . . , 52-N2 of the translation ring 52.

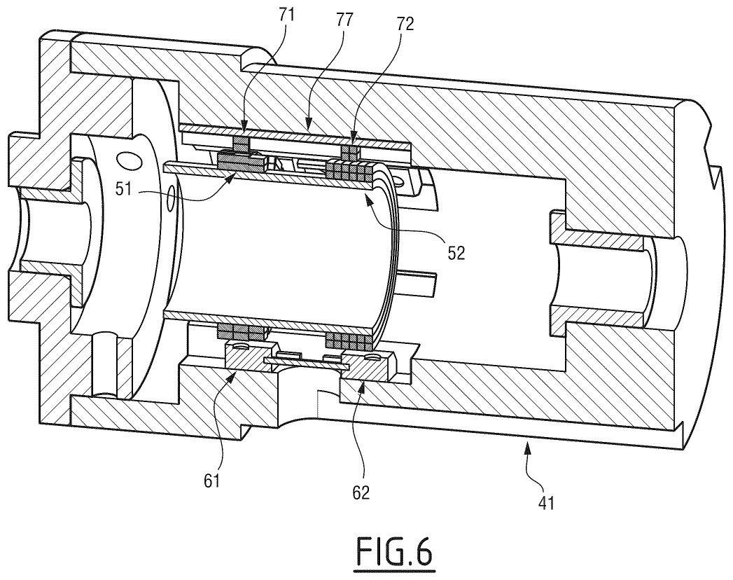

With reference to FIGS. 4 and 6, the functional internal elements of the fixed body 22 include at least one pair of translational magnetic detectors 62, also known as second magnetic detectors, at least one pair of rotational magnetic detectors 61, also known as first magnetic detectors, a plurality of translational notching teeth 72, also known as second notching teeth, and a plurality of rotational notching teeth 71, also known as first notching teeth. These elements 61, 62, 71, 72 are fixed to an inner surface of the support 41 (not shown in FIG. 4) of the fixed body 22. In addition, as mentioned previously, these elements 61, 62, 71, 72 are kept at a distance from the corresponding rings 51 and 52.

The magnetic translation detectors 62 are arranged opposite the translation ring 52 and make it possible to quantify the movement of this ring 52 along the encoder axis X. In other words, these detectors 62 make it possible to code each movement of the translation ring 52 along the encoder axis X by detecting changes in the magnetic flux thanks to the axial magnetic alternation of the elementary rings making up this translation ring 52. For example, the translation detectors 62 are offset from each other by a fraction of the translational notch step defined by this translation ring 52. Advantageously, the number of translation detectors 62 is 3. These translation detectors 62 are, for example, evenly spaced in the circumferential direction.

The magnetic rotation detectors 61 are positioned opposite the rotation ring 51. The rotation detectors 61 make it possible to quantify each rotary movement of the rotation ring 51 about the encoder axis X by detecting changes in the magnetic flux thanks to the circumferential magnetic alternation implemented by the elementary parts of each elementary ring 51-1, . . . , 51-N1 constituting the rotation ring 51. For example, the magnetic detectors 61 are offset by a fraction of the smallest rotational notch step defined by the rotation ring 51. Advantageously, the number of rotation detectors 61 is 3. These rotation detectors 61 are, for example, evenly spaced in the circumferential direction.

Each magnetic detector 61, 62 has, for example, a Hall effect sensor or a magneto-resistive sensor or a solenoid. In addition, each magnetic detector 61, 62 is connected to an external controller of the encoder 10 by cables 74 visible in FIG. 3.

Each translational notching tooth 72 is arranged opposite the translation ring 52. In particular, each translational notching tooth 72 has a surface which is oriented towards the translation ring 52 and has a dimension less than or equal to the translational notch step. Such a surface has, for example, a longitudinal extent which is less than or equal to the notch step of the ring 52. In addition, each translational notching tooth 72 is made of a ferromagnetic or magnetic material such as 400 series stainless steel. Each translational notching tooth 72 is preferably a magnet or a plurality of magnets arranged side by side. Each magnet is, for example, a parallelepiped magnet or an arc magnet. Such a magnet is, for example, derived from a “poly magnet” or a “programmable magnet” called Polymagnets®.

In the example shown in FIG. 4, when the translation ring 52 is made up of a central pair of elementary rings and two peripheral pairs, each translational notching tooth 72 defines a stable position in which it is arranged opposite the central pair. To ensure such a stable position, each translational notching tooth 72 includes, for example, a pair of magnets arranged side by side along the encoder axis X and having magnetizations in opposite directions to those of the outer surface of the central pair of elementary rings.

In some embodiments, a stable position of each translational notching tooth 72 is also formed when this translational notching tooth 72 is arranged facing one of the peripheral pairs of elementary rings, advantageously facing each peripheral pair of elementary rings. In such a case, each movement of the movable body 21 along the encoder axis X between the different stable positions may then be carried out manually by the operator. Furthermore, preferably, the width of each elementary ring 51-1, . . . , 51-N1 of the rotation ring 51 is substantially equal to the width of each pair of elementary rings 52-1, . . . , 52-N2 of the translation ring 52.

In certain other embodiments, an unstable position of each translational notching tooth 72 is formed when this translational notching tooth 72 is disposed opposite one of the peripheral pairs of elementary rings, advantageously opposite each peripheral pair of elementary rings. In such a case, a mechanical stop may be provided along each direction of movement of the movable body 21 along the encoder axis X. This mechanical stop prevents each translational notching tooth 72 from being aligned with the corresponding peripheral pair of elementary rings and thus from reaching a stable magnetic position. In this case, the movable body 21 is returned magnetically along the encoder axis X from an unstable position to the stable position. Furthermore, preferably, the width of each peripheral elementary ring 51-1, . . . , 51-N1 of the rotation ring 51 is substantially less than the width of the corresponding peripheral pair of elementary rings 52-1, . . . , 52-N2 of the translation ring 52.

Each rotational notching tooth 71 is arranged opposite the rotation ring 51. As in the previous case, each rotational notching tooth 71 has a surface facing the rotation ring 51 with a circumferential dimension less than or equal to that of the smallest rotational notching step and an axial dimension less than or equal to the width of each elementary ring 51-1, . . . , 51-N1 constituting the rotation ring 51. In addition, each rotational notching tooth 71 is made of a ferromagnetic or magnetic material such as 400 series stainless steel. Each rotational notching tooth 71 is preferably a magnet. Each magnet is, for example, a parallelepiped magnet or an arc magnet. Such a magnet is, for example, derived from a “poly magnet” or a “programmable magnet” called Polymagnets®.

As shown in FIG. 6, the notching teeth associated with the different rings 51, 52 are advantageously connected together by a connecting piece 77. This connecting piece 77 is, for example, a magnetic or ferromagnetic part, and advantageously extends along the encoder axis X.

Advantageously, when the translational notching teeth 72 face the central pair of elementary rings of the translation ring 52, the rotational notching teeth 71 face the central elementary ring of the rotation ring 51. In this position, an average rotational notch step is applied during a rotary movement. When the translational notching teeth 72 are opposite one of the peripheral pairs of elementary rings of the translation ring 52 following a translational movement of the movable body (PUSH or PULL), a fine or coarse rotational notch step is applied during a successive rotary movement.

In addition, in the example shown in FIG. 4, a plurality of notching teeth 71, 72 are associated with each of the rings 51, 52. In particular, in the example shown here, three notching teeth are associated with each of the rings. Generally speaking, to improve the balance of the encoder and avoid parasitic torque or force, it is preferable to have at least two notching teeth associated with each of the rings and distributed equidistantly in the circumferential direction.

Advantageously, according to the invention, when such a plurality of notching teeth is associated with a ring, the notching teeth are arranged equidistantly along the circumferential direction of the corresponding ring 51, 52. It should also be understood that a single notching tooth for each ring would be sufficient to ensure a notch function in the corresponding direction.

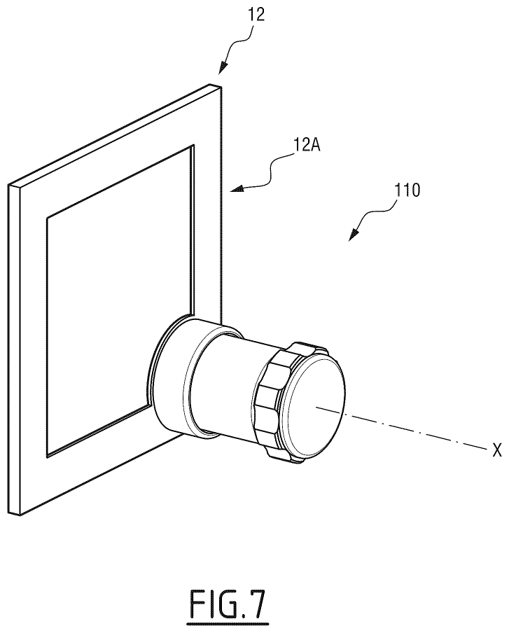

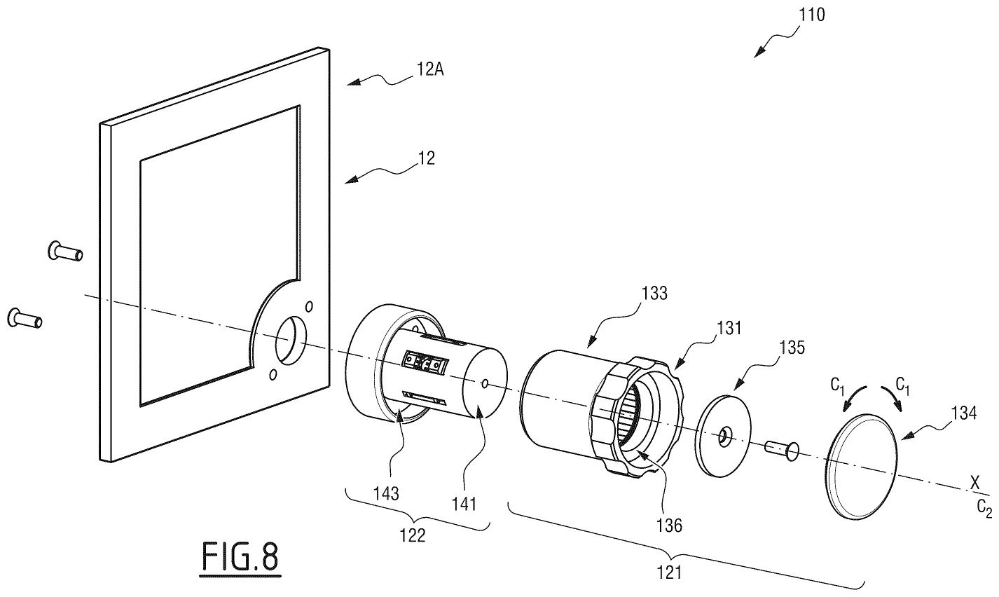

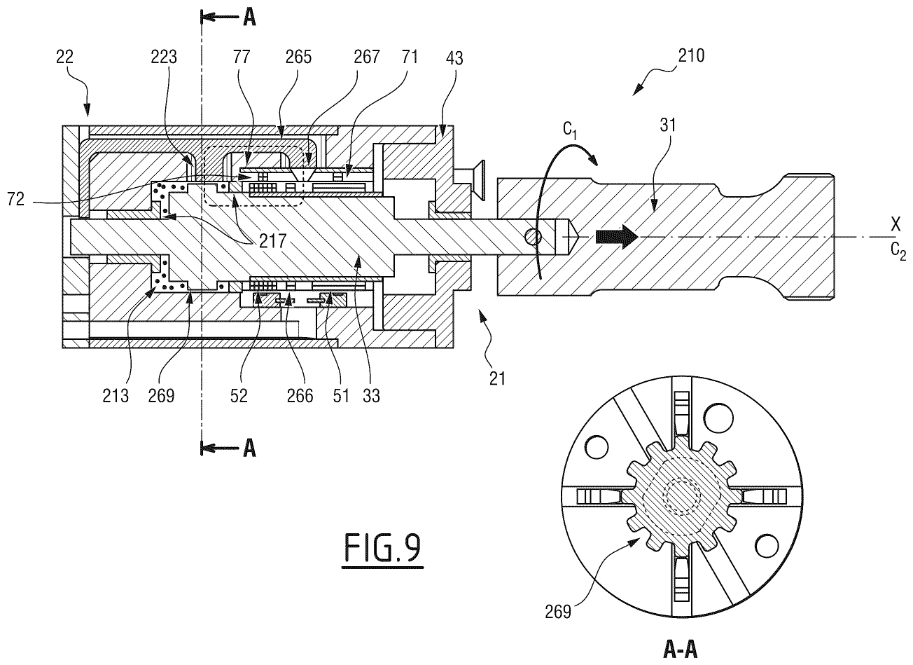

The encoder 110 in a second embodiment will now be explained with reference to FIGS. 7 and 8. The application of this encoder 110 is, for example, identical to that of the encoder 10 explained above.

The main difference between the encoder 110 in the second embodiment is the way it is arranged in relation to the panel 12. As shown in FIG. 7, the encoder 110 in the second embodiment is located entirely in the front part 12A of the panel 12.

As shown in FIG. 8, like the encoder 10 in the first embodiment, the encoder 110 in the second embodiment includes a movable body 121, also known as the first body, and a fixed body 122, also known as the second body.

The fixed body 122 is fixed, for example, directly to the front part 12A of the panel 12. As in the previous case, the fixed body 122 includes a support 141 receiving the functional internal elements of this fixed body 122 as will be explained in more detail later. The support 141 may also include a mechanical stop 143 integrated into one of its ends.

As in the previous case, the movable body 121 also includes a knob 131 and a rotor 133 which is, for example, integral with the knob 131 arranged on its end. The same end of the rotor 133 is closed, for example, by a cover 134 with a surface facing the operator. The cover 134 is connected to the rotor 133. A washer 135 is integral with the fixed body 122 at its end. This washer 135 may act as a mechanical stop during rotation or translation of the movable body 121. This mechanical stop may be damped by a return spring or an elastomer part (example material: EPDM). This stop may also be magnetic. In this case, the stop may be made by placing a magnet attached to the fixed body in repulsion and facing a magnet attached to the movable body. This magnetic stop is intrinsically damped. This magnetic stop may be independent or part of one of the rings (to optimize the number of parts). For example, in the case of a movable body ring using a Halbach-type arrangement, a fixed body magnet may be placed in repulsion and facing the end of this ring having locally axial or circumferential magnetization. In addition, at each of its ends, the rotor 133 may have bearings 136 intended to cooperate with the fixed body 122 in order to ensure the movement of the movable body 121 in each of the encoding directions, namely a first encoding direction C1 corresponding to the direction of rotation about this encoder axis X and a second encoding direction C2 corresponding to the direction of translation along the encoder axis X, in the example of the figures.

Unlike the previous case, the rotor 133 is designed to at least partially enclose the fixed body 122. In other words, the rotor 133 is designed to be arranged around the support 141 as shown in FIG. 8.

In addition, as in the previous case, the movable body 121 includes a rotation ring, also known as the first ring, and a translation ring, also known as the second ring. These rings are similar to the rings 51 and 52 described above. In particular, the translation ring may have a single magnetic alternation and the rotation ring may have several magnetic alternations.

In contrast to the previous case, the rotation and translation rings in the second embodiment are arranged on an inner surface of the rotor 133, which then has a hollow rotary shaft as shown in this figure. Each of these rotation and translation rings is fixed on a shaft along the encoder axis X and remains spaced from the other ring.

Also analogous to the previous case, the fixed body 122 includes a plurality of pairs of magnetic detectors and a plurality of notching teeth, arranged opposite the corresponding rotation and translation rings.

In contrast to the previous case, the functional internal elements (i.e., the magnetic detectors and the notching teeth) of the fixed body 122 of the encoder 110 according to the second embodiment, are arranged on an external surface of the support 141 or at least in closed windows on this surface. According to this design, these elements are positioned opposite the inner surfaces of the corresponding rings. In other words, according to this design, the functional internal elements of the fixed body 122 are received inside the rings while remaining at a distance from them. The operation and respective arrangement of these internal elements are similar to those described previously in relation to the first embodiment.

The encoder 210 in a third embodiment will now be explained with reference to FIG. 9. The application and structure of this encoder 210 are substantially similar to those of the encoder 10 in the first embodiment. In particular, this encoder 210 includes all the elements of the encoder 10 according to the first embodiment. These common elements will be referred to by the same numerical references as in the first embodiment and will not be described in detail in relation to this embodiment. It should be understood, however, that at least some of these elements may be adapted to cooperate with the elements specific to this embodiment which will be explained below.

With reference to FIG. 9, the encoder 210 in the third embodiment defines a gap 213 between the movable body 21 and the fixed body 22. This space 213 is configured to be filled with a magneto-rheological fluid.

In particular, this space 213 is for example delimited by part of an external surface of the rotor 33 and a surface of a cavity of the fixed body 22 receiving the rotor 33. This space 213 extends circumferentially around the rotor 33 and axially along the encoder axis X substantially between the bearings 37 disposed on a distal end of the rotor 33 and the second ring 52. This distal end is opposite the end that receives the knob 31. The space 213 may be axially delimited by a pair of seals 217.

In a manner known per se, the magneto-rheological fluid has suspensions of particles of a few micrometers, or even a few nanometers, which enable the apparent viscosity of the fluid to be modified as a function of the intensity of a magnetic field passing through it.

According to this method, the apparent viscosity of the magneto-rheological fluid is modified to modify the notch torque in the first encoding direction C1, i.e., in the direction of rotation of the rotor 33. For example, by changing the apparent viscosity of the magneto-rheological fluid, it is possible to switch from a potentiometric state (torque with virtually no notch) to an incremental state (notch torque with variable step or variable torque).

To modify the magnetic field passing through the magneto-rheological fluid and therefore to modify its apparent viscosity, the encoder 210 includes a magnetic loop 223 enabling a magnetic field to be created with a variable intensity in space 213.

In addition, the magnetic loop 223 is configured to modify the intensity of the magnetic field in the space 213 as a function of the position of the rotor 33 along the encoder axis X. In other words, this magnetic loop 223 makes it possible to modify the intensity of the magnetic field in space 213 as a function of the translational movement of the movable body 21.

According to the example in FIG. 9, the magnetic loop 223 includes a magnetic or ferromagnetic element 265 extending at least partially around the space 213, a magnetic ring 266 arranged on the rotor 33 and a looping tooth 267 capable of closing the magnetic loop 223 when this tooth 267 is arranged opposite the magnetic ring 266.

For example, the magnetic ring 266 has an outer surface with the same magnetic polarization. This ring 266, for example, is fixed to the rotor 33 between the first ring 51 and the second ring 52.

The looping tooth 267, for example, is positioned on the connecting piece 77 between the corresponding notching teeth 71, 72. The looping tooth 267 is made, for example, of a magnetic or ferromagnetic material. For example, it is in permanent contact with the magnetic or ferromagnetic element 265. In some examples, a looping tooth 267 may be arranged on each connecting piece 77.

The magnetic ring 266 may move in translation with the rotor 33 relative to the looping tooth 267. Thus, each movement along the encoder axis X of the rotor 33 modifies the alignment of the looping tooth 267 with respect to the magnetic ring 266 and therefore the intensity of the magnetic field formed by the magnetic loop 223.

In other embodiments, the magnetic loop 223 may be formed by other means. These means may be passive, i.e., operating without a specific power supply, as is the case with magnets, or active, i.e., requiring a power supply, as is the case, for example, with a magnetic coil.

In addition, in the example shown in FIG. 9, a toothed wheel 269 is arranged on the rotor 33 so that it may rotate in the space 213 in the direction of rotation C1 in any position of the rotor 33 relative to the encoder axis X. This toothed wheel 269 thus makes it possible to create or reinforce discrete notches during rotation of the rotor 33 in at least one predetermined position of the rotor 33 relative to the encoder axis X.

Of course, other designs are also possible. For example, it must be understood that the notion of a first body with all its associated elements may be applied to a fixed body and the notion of a second body with all its associated elements may be applied to a movable body. In addition, a plurality of magnetic alternations may be applied to the translation ring and a single magnetic alternation may be applied to the translation ring. Finally, the principles of a magnetic loop and of a magneto-rheological fluid modifying its apparent viscosity as a function of the intensity of the magnetic field created by the loop may be applied to the encoder structure described in relation to the second embodiment.

1. An incremental magnetic encoder defining an encoder axis and comprising a fixed body and a body movable relative to the fixed body in at least a first encoding direction and a second encoding direction perpendicular to the first encoding direction, wherein one of the bodies, referred to as the first body, comprises a first ring extending along a first longitudinal direction coincident with the encoder axis and a first circumferential direction perpendicular to the first longitudinal direction, one of the first directions corresponding to the first encoding direction, the first ring defining at least two different magnetic alternations, each magnetic alternation extending along the first encoding direction, and the other body, referred to as the second body, comprises:
at least one first notching tooth comprising ferromagnetic or magnetic material capable of being arranged opposite each magnetic alternation of said first ring to create, during a movement of the movable body in the first encoding direction, a notch with at least two different notch steps depending on the position of the second body relative to said first body in the second encoding direction; and
a first pair of magnetic detectors arranged opposite said first ring and configured to quantify each movement of the movable body in the first encoding direction.

2. The encoder according to claim 1, wherein each magnetic alternation is defined by a constant alternation step.

3. The encoder according to claim 1, wherein said first body further comprises a second ring extending along a second longitudinal direction coincident with the encoder axis and a second circumferential direction perpendicular to the second longitudinal direction, one of the second directions corresponding to the second encoding direction, the second ring defining a single magnetic alternation extending along the second encoding direction, and wherein said second body further comprises:
at least one second notching tooth comprising ferromagnetic or magnetic material arranged opposite said second ring to create a set of notches with the same notch step when the movable body moves in the second encoding direction; and
a second pair of magnetic detectors arranged opposite said second ring and configured to quantify each movement of the movable body in the second encoding direction.

4. The encoder according to claim 3, wherein said second ring defines at least one central notch and two peripheral notches, a translationally stable position being defined when said at least one second notching tooth is positioned opposite the central notch.

5. The encoder according to claim 1, wherein the second encoding direction corresponds to a translation along the encoder axis according to a predetermined translational stroke length and the first encoding direction corresponds to a rotation about the encoder axis.

6. The encoder according to claim 5, wherein said first ring comprises a plurality of elementary rings arranged coaxially next to one another in the second encoding direction, at least two elementary rings defining the two different magnetic alternations.

7. The encoder according to claim 6, wherein said plurality of elementary rings comprises at least three elementary rings arranged coaxially next to one another in the second encoding direction, the elementary rings defining at least three different magnetic alternations with an increasing or decreasing alternation step in the second encoding direction.

8. The encoder according to claim 6, wherein the first body further comprises a second ring extending along a second longitudinal direction coincident with the encoder axis and a second circumferential direction perpendicular to the second longitudinal direction, one of the second directions corresponding to the second encoding direction, the second ring defining a single magnetic alternation extending along the second encoding direction, the second ring comprising a plurality of elementary rings arranged coaxially next to each other to define the magnetic alternation along the second encoding direction, the width of each elementary ring of said first ring being less than or equal to the width of each pair of elementary rings of the second ring, and wherein the second body further comprises:
at least one second notching tooth made of ferromagnetic or magnetic material arranged opposite said second ring to create a set of notches with the same notch step when the movable body moves in the second encoding direction; and
a second pair of magnetic detectors arranged opposite said second ring and configured to quantify each movement of the movable body in the second encoding direction.

9. The encoder according to claim 1, wherein the surface of said at least one first notching tooth has an extent less than or equal to the smallest notch step of the corresponding ring.

10. The encoder according to claim 1, wherein the magnetic detectors of the first same pair of detectors are offset from one another by a fraction of the smallest notch step.

11. The encoder according to claim 1, wherein the first body is said movable body and the second body is said fixed body.

12. The encoder according to claim 1, further comprising:
a magneto-rheological fluid in a space formed between the first body and the second body;
a magnetic loop configured to form a magnetic field at least in part of the space and to modify the intensity of this magnetic field as a function of the position of the second body relative to the first body along the second encoding direction.
